(19) United States
(12) Patent Application Publication
(10) Pub. No.: US 2016/0080303 A1
(43) Pub. Date: Mar. 17, 2016

(54) DETERMINING TOPIC RELEVANCE OF AN EMAIL THREAD

(71) Applicant: HEWLETT-PACKARD DEVELOPMENT COMPANY, L.P., Houston, TX (US)

(72) Inventors: Vinay Deolalikar, Cupertino, CA (US); Hernan Laffitte, Mountain View, CA (US)

(21) Appl. No.: 14/786,350

(22) PCT Filed: Jul. 30, 2013
(86) PCT No.: PCT/US2013/052631

§ 371 Date: Oct. 22, 2015

(51) Int. Cl. H04L 12/58

(52) U.S. Cl. CPC H04L 51/16

(57) ABSTRACT

A method for determining topic relevance of an email thread with an electronic device is described. The method includes removing redundancy from email messages in an email thread, grouping a number of email threads into a number of email clusters, identifying high information gain terms for each email cluster, identifying topic terms for each email cluster from the high information gain terms and determining a relevance of the number of email threads in an email cluster based on the topic terms for the email cluster and a threshold number of email messages in an email thread.

### BACKGROUND

Email is frequently used in electronic communication and information storage. Email is implemented in large and complex organizational structures and an increased interaction among different organizations. These emails may contain crucial information that organizations may want at a later time. Accordingly, organizations may store email messages in a repository for record-keeping and for later retrieval and use.

### BRIEF DESCRIPTION OF THE DRAWINGS

The accompanying drawings illustrate various examples of the principles described herein and are a part of the specification. The illustrated examples do not limit the scope of the claims.

FIG. 1 is a diagram of a system for determining topic relevance of an email thread, according to one example of the principles described herein.

FIG. 2 is a diagram of an email thread, according to one example of the principles described herein.

FIG. 3 is a flowchart of a method for determining topic relevance of an email thread, according to another example of the principles described herein.

FIG. 4 is a flowchart of a method for determining topic relevance of an email thread, according to still another example of the principles described herein.

FIG. 5 is a diagram of a management device, according to one example of the principles described herein.

FIG. 6 is a diagram of a management device, according to another example of the principles described herein.

Throughout the drawings, identical reference numbers designate similar, but not necessarily identical, elements.

### DETAILED DESCRIPTION

Email provides a useful tool to enhance an organization's communication infrastructure. In addition, email may allow different organizations to communicate with one another. The email messages shared between users of an organization, or between users of different organizations, may include valuable information that an organization may wish to store for record-keeping and to retrieve at a later point. Accordingly, an organization may implement an email repository that stores a body of email messages. The email messages, or email corpus, may then be accessed at a later point to retrieve the information contained in the email messages.

Email messages may include at least two types of information. Topic information that may relate to the topical substance of an email message, and context information that may not directly relate to the topic of an email thread. Examples of context information include information relating to people, locations, and times, among other contextual elements. An example is given as follows. An email message may introduce a subject and propose a meeting about the subject in a particular conference room. In this email message, the introduction to the subject may be topic information, and the meeting and suggested conference room may be context information. In this example, the topic information may determine whether a particular email message, or email thread is relevant. Accordingly, during a subsequent search, topic information may be identified and the relevance of an email message, or an email thread, determined.

However, current methods for determining relevance of an email message or email thread may be inefficient. For example, large email corpora, which may not be stored in threaded form, may be “mined” or have information extracted therefrom. A standard method is to group similar email messages and individually determine whether each email message of an email thread contains valuable information as determined by a user. Such a process can be cumbersome as each message in each group may be individually mined. Additionally, the nature of email messages to include quoted text, forwarded text, signature templates and boiler plate may render current text-mining procedures ineffective for email messages. Due to these characteristics, determining whether each email message in a group contains valuable information may be redundant, may yield inaccurate or irrelevant results, and may use valuable processing time.

The present disclosure describes a method for determining topic relevance of an email thread with an electronic device. The method may include removing redundancy from email messages in an email thread. The method may also include grouping a number of email threads into a number of email clusters. The method may further include identifying high information gain terms for each email cluster. The method may further include identifying topic terms for each email cluster from the high information gain terms. Lastly, the method may include determining a relevance of the number of email threads in an email cluster based on the topic terms for the email cluster and a threshold number of email messages in an email thread.

The present disclosure also describes a system for determining topic relevance of an email thread. The system may include a remove engine that may de-duplicate quoted text from email messages in an email thread. A cluster engine may cluster a number of email threads into email clusters. A terms engine may identify a number of topic terms for each of the email clusters. A relevancy engine may determine a relevance of the number of email threads in the email clusters based on the number of topic terms and a threshold number of email messages in each email thread.

The present disclosure also describes a computer program product for determining topic relevance of an email thread. The computer program product may include a computer readable storage medium that includes computer usable program code embodied therewith. The computer usable program code may include computer usable program code to, when executed by a processor, remove quotations of a first number of email messages from a second number of email messages in an email thread. The computer usable program code may also include computer usable program code to, when executed by a processor, cluster a number of email threads into a number of email clusters. The computer usable program code may also include computer usable program code to, when executed by a processor, determine a number of high information gain terms in an email cluster. The computer usable program code may also include computer usable program code to, when executed by a processor, determine a number of topic terms from the number of high information gain terms. The computer usable program code may also include computer usable program code to, when executed by a processor, determine the relevancy of a number of email threads within each email cluster based on the topic terms.

The system and method described herein may be beneficial in that relevant email threads are quickly identified by analyzing those email messages most likely to include substantive information about a particular topic. Accordingly, the methods and systems described herein speed up various knowledge gathering and text-mining tasks on an email corpus by quickly identifying portions of an email corpus that are likely to contain information relevant to a determined topic.

As used in the present specification and in the appended claims, the term “email thread” may be a grouping of email messages that share a common characteristic. For example, email messages in an email thread may be replies to, forwards of, or otherwise associated with another email message.

Further, as used in the present specification and in the appended claims, the term “leading email messages” may be the first few email messages in an email thread. For example, the leading email messages may be the first two email messages in an email thread. In another example, the leading email messages may be the first three email messages in an email thread.

Still further, as used in the present specification and in the appended claims, the term “origination message” may be an email message that is the first email message in an email thread. As will be described below, an origination message may be identified as such by determining whether the email message quotes a previous email message.

Still further, as used in the present specification and in the appended claims, the term “relevant” may refer to an email thread that relates to a topic of an email cluster. As will be described below, whether an email thread is relevant may be determined based on the topic information in the email thread and topic terms from an email cluster.

Still further, as used in the present specification and in the appended claims, the term “cluster” may refer to groups of email messages that are more similar to each other in some way than email messages in other clusters.

Lastly, as used in the present specification and in the appended claims, the term “a number of” or similar language may include any positive number including 1 to infinity; zero not being a number, but the absence of a number.

In the following description, for purposes of explanation, numerous specific details are set forth in order to provide a thorough understanding of the present systems and methods. It will be apparent, however, to one skilled in the art that the present apparatus, systems, and methods may be practiced without these specific details. Reference in the specification to “an example” or similar language means that a particular feature, structure, or characteristic described is included in at least that one example, but not necessarily in other examples.

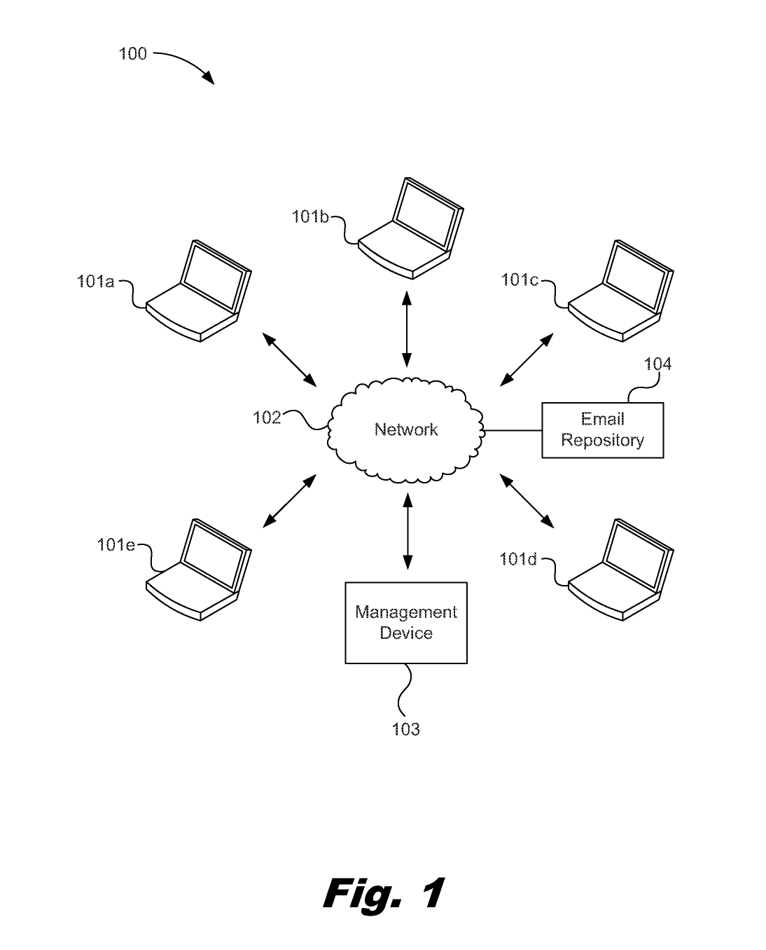

Referring now to the figures, FIG. 1 is a diagram of a system (100) for determining topic relevance of an email thread, according to one example of principles described herein. The system (100) may include a number of user devices (101). In one example, a user uses a user device (101) to access a network (102). Examples of user devices (101) include desktop computers, laptop computers, smartphones, personal digital assistants (PDAs), and tablets, among other electronic devices. In other words, a user device (101) may be any electronic device that allows a user to communicate with another electronic device.

The users may communicate with one another via a network (102). A network (102) may be a forum that facilitates many users communicating with one another. In some examples, the network (102) may be an email network, and users may communicate with one another via email messages shared over the network (102). In this example, the network (102) may include at least one engine that allows users to transmit and receive email messages from other user devices (101). For example, a user within a business organization may send an email message to at least one other user of the business organization via the network (102).

As mentioned above, email messages may include valuable information that users may want to retrieve at a later point in time. Accordingly, the email messages may be stored for later use. To this end, the network (102) may be coupled to an email repository (104) that stores the email messages. As used herein, the email messages that are stored in the email repository (104) may be referred to as an email corpus. In some examples, the email messages in the email corpus may be organized in a non-threaded form. An email thread may include email messages that relate to one another. For example, an email thread may include email messages that are forwards of, replies to or otherwise associated with one another. Accordingly, an email corpus that is organized in a non-threaded form may not associate forwards of an email message, or replies to an email message, with the corresponding email message.

A management device (103) may manage the determination of whether an email thread is relevant. More specifically, the management device (103) may remove redundancy from email messages in an email thread. The management device (103) may also group email threads into email clusters and determine topic terms for each of the email dusters. As will be described in more detail below, determining topic terms may include, identifying high information gain terms for each email cluster, and from those high information gain terms, identifying topic terms that relate to the topic of the email cluster. The management device (103) then analyzes the email threads in the email clusters, or a few particular email messages of the email threads, to determine whether each email thread is relevant to the topic of the email cluster. In summary, the management device (103) may identify topic terms of an email cluster, and then analyze a few email messages of the email threads in the email cluster to determine whether each email thread is relevant to the topic of the email cluster.

Determining the relevance of an email thread based on the first few email messages, or leading email messages, of an email thread may be beneficial in that it reduces the time to complete knowledge gathering processes as the management device (103) analyzes a subset of the email thread (i.e., the first few messages), rather than the entire email thread. Moreover, the utility of the topic mining is not reduced as the leading email messages contain a significant portion of the topic-related information. Accordingly, using just a few email messages of an email thread to determine relevance reduces extraneous processing, increases the efficiency of data-mining, while preserving the utility of the data-mining.

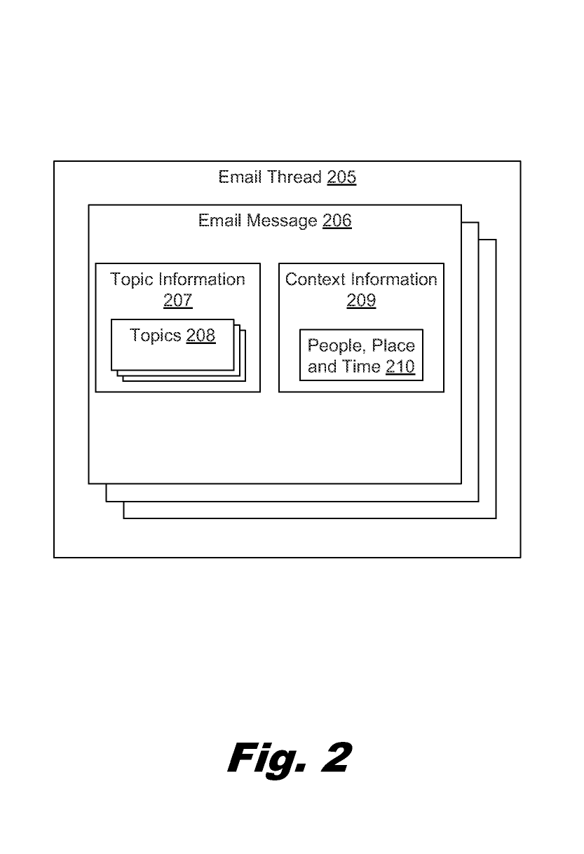

FIG. 2 is a diagram of an email thread (205), according to one example of the principles described herein. As described above, an email thread (205) may include a number of email messages (206) that relate to one another. For example, an email thread (205) may include a first, or origination, email message (206). The email thread (205) may also include a second email message (206) that is a reply to the first email message (206). The email thread (205) may also include a third email message (206) that is a forward of the second email message (206). Email messages (206) may have different types of information. For example, an email message (206) may include topic information (207). Topic information may include information that identifies a topic (208) of an email message (206). As depicted in FIG. 2, each email message (206) may have topic information (207) that identifies a number of topics (208) of the email message (206). As described above, the topic information (207) may determine the relevance of an email message (206) or an email thread (205). Accordingly, the management device (FIG. 1, 103) may determine the relevance of an email thread based on the topic information (207).

An email message (206) may also include context information (209). Context information (209) provides context for the topic (208). For example, context information (209) may include people, place and time (210) information, among other contextual information. As mentioned above, and as will be described in detail below, the management device (FIG. 1, 103) may analyze the topic information (207) of an email message (206) while avoiding analyzing the context information (209) of an email message (206) when determining relevance of an email thread (205). In some examples, the leading email messages (206) of an email thread (205) may contain a greater concentration of topic information (207) than the non-leading email messages (206). Accordingly, the non-leading messages (206) may contain a greater concentration of context information (209) than the leading email messages (206).

An example of topic information (207) and context information (209) is given as follows. An email message (206) may include an introduction to a subject and propose a meeting amongst the recipients of the email message (206) in a particular conference room at a particular time. In this example, the introduction to the subject may be topic information (207) and the listed recipients, conference room and particular time may be context information (209). Accordingly, the management device (FIG. 1, 103) may analyze the topic information (207) to determine whether an email thread (205) is relevant. At the same time, the management device (FIG. 1, 103) may avoid analyzing the context information (209). Analyzing just the topic information (207) as described herein may be beneficial in that it focuses knowledge gathering on the portion of an email thread (205) that is most likely relevant, while avoiding analysis of portions of the email thread (205) that may not be as relevant.

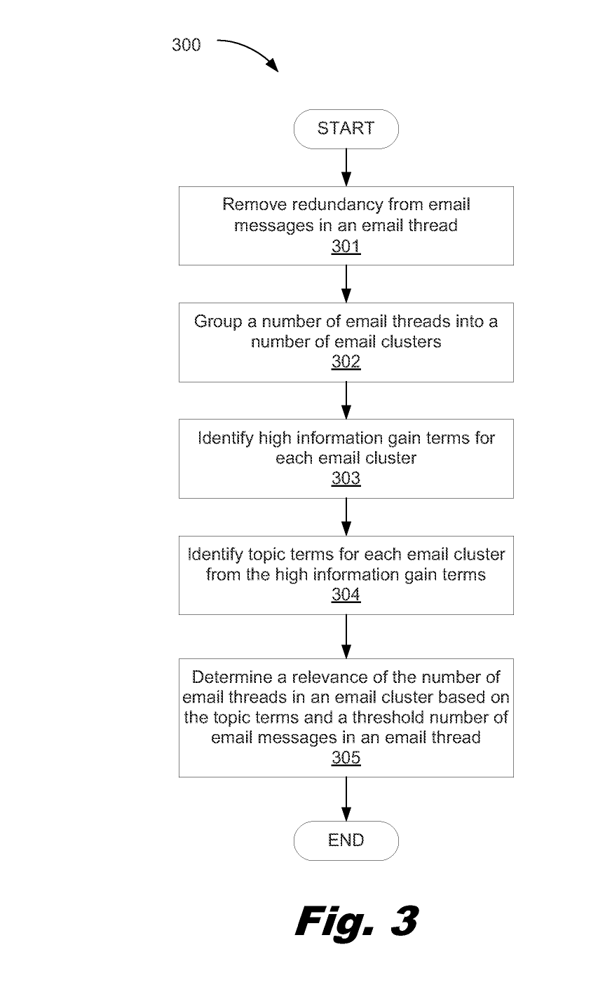

FIG. 3 is a flowchart of a method (300) for determining topic relevance of an email thread (FIG. 2, 205), according to one example of the principles described herein. The method (300) may be performed by the management device (FIG. 1, 103). The management device (FIG. 1, 103) may remove (block 301) redundancy from email messages (FIG. 2, 206) in an email thread (FIG. 2, 205). An email thread (FIG. 2, 205) may include a number of email messages (FIG. 2, 206) that relate to one another. For example, an email thread (FIG. 2, 205) may include forwards of, and replies to, email messages (FIG. 2, 206). In some examples, the subsequent email messages (FIG. 2, 206) may quote previous email messages (FIG. 2, 206). In other words, a second email message (FIG. 2, 206) may include a first email message (FIG. 2, 206) in its entirety. Accordingly, the management device (FIG. 1, 103) may remove (block 301) redundancy from an email thread (FIG. 2, 205) by removing the quotations of earlier email messages (FIG. 2, 206) by subsequent email messages (FIG. 2, 206). Removing (block 301) redundancies as described herein may be beneficial in that subsequent email messages (FIG. 2, 206) may not be identified as relevant merely because they quote earlier, and previously analyzed, topic information (FIG. 2, 207).

The management device (FIG. 1, 103) may also group (block 302) a number of email threads (FIG. 2, 205) into a number of email clusters. As described above, an email cluster is a group of email threads (FIG. 2, 205) that are more similar to one another than to email threads (FIG. 2, 205) in another email cluster. For example, a “sports” cluster may be a number of email threads (FIG. 2, 205) that relate to sports. By comparison, a “politics” cluster may be a number of email threads (FIG. 2, 205) that relate to politics.

The management device (FIG. 1, 103) may identify (block 303) a number of high information gain terms for each email cluster. High information gain terms may be those terms that were more prevalent in the email cluster. Identifying (block 303) high information gain terms may include implementing a statistical function or process to determine which terms in an email cluster describe the grouping of the cluster. In other words, the high information gain terms may be those terms deemed valuable when grouping the email threads (FIG. 2, 205) into email clusters. In some examples, the number of identified high information gain terms may be approximately 20-25.

From the number of high information gain terms, the management device (FIG. 1, 103) may identify (block 304) topic terms for each email cluster. Topic terms are those terms that are high information gain terms and that relate to the topic of the email cluster. In some examples, the number of topic terms may be approximately 8-10.

An example illustrating the difference between high information gain terms and topic terms is described as follows. An email thread (FIG. 2, 205) in an email cluster may include a first email message (FIG. 2, 206) that may introduce a topic of a new road construction project in California and may also propose a meeting Wednesday morning. Subsequent email messages (FIG. 2, 206) in the email thread (FIG. 2, 205) may propose different meeting times on Wednesday; for example, meeting on Wednesday afternoon, as opposed to Wednesday morning. In this example, the high information gain terms of an email cluster may include “road,” “construction,” “California,” “Wednesday,” “morning,” and “afternoon.” From these terms, the topic terms may include “road,” “construction,” and “California,” as these terms relate to the topic of a road construction project in California.

The management device (FIG. 1, 103) may then determine (block 305) a relevance of the number of email threads (FIG. 2, 205) in an email cluster based on the topic terms and based on a threshold number of email messages (FIG. 2, 206) in an email thread (FIG. 2, 205). Relevant email threads (FIG. 2, 205) may be those email threads (FIG. 2, 205) that include topic information (FIG. 2, 207) that relates to the topic of the email cluster. For example, the management device (FIG. 1, 103) may determine which of the email threads (FIG. 2, 205) in an email cluster contain topic information (FIG. 2, 207) that is relevant to the topic as defined by the topic terms. In some examples, the management device (FIG. 1, 103) may determine (block 305) the relevance of email threads (FIG. 2, 205) based on a threshold number of email messages (FIG. 2, 206) in the email threads (FIG. 2, 205). For example, the management device (FIG. 1, 103) may determine a relevance (block 305) of an email thread (FIG. 2, 205) based on the leading email messages (FIG. 2, 206) in an email thread (FIG. 2, 205). As described above, leading email messages (FIG. 2, 206) may be the first few email messages (FIG. 2, 206) of an email thread (FIG. 2, 205) that contain a greater concentration of the topic information (FIG. 2, 207), i.e., information that relates to the substance of an email message (FIG. 2, 206). Subsequent email messages (FIG. 2, 206) may contain topic information (FIG. 2, 207) but may also contain a large portion of context information (FIG. 2, 209) (i.e., people, place and time information (FIG. 2, 210)), that may not be relevant. Accordingly, determining (block 305) relevance based on a few initial email messages (FIG. 2, 206) may be beneficial in that the pool of email messages (FIG. 2, 206) analyzed for relevance is reduced as just a few email messages (FIG. 2, 206) are analyzed, rather than the entire email thread (FIG. 2, 205).

Identifying a few of the email messages (FIG. 2, 205) that contain a greater concentration of the topic information (FIG. 2, 207) and determining relevance of an email thread (FIG. 2, 205) based on those email messages (FIG. 2, 206) may be beneficial by reducing the pool of email messages (FIG. 2, 206) analyzed to determine relevance of an email thread (FIG. 2, 205). Moreover, as described above, the utility of the topic mining is not reduced as a large percentage of the topic information (FIG. 2, 207) for an email thread (FIG. 2, 205) is found in the initial email messages (FIG. 2, 206) of an email thread (FIG. 2, 205). Accordingly, topic mining processing time may be reduced and the value of the topic mining is preserved.

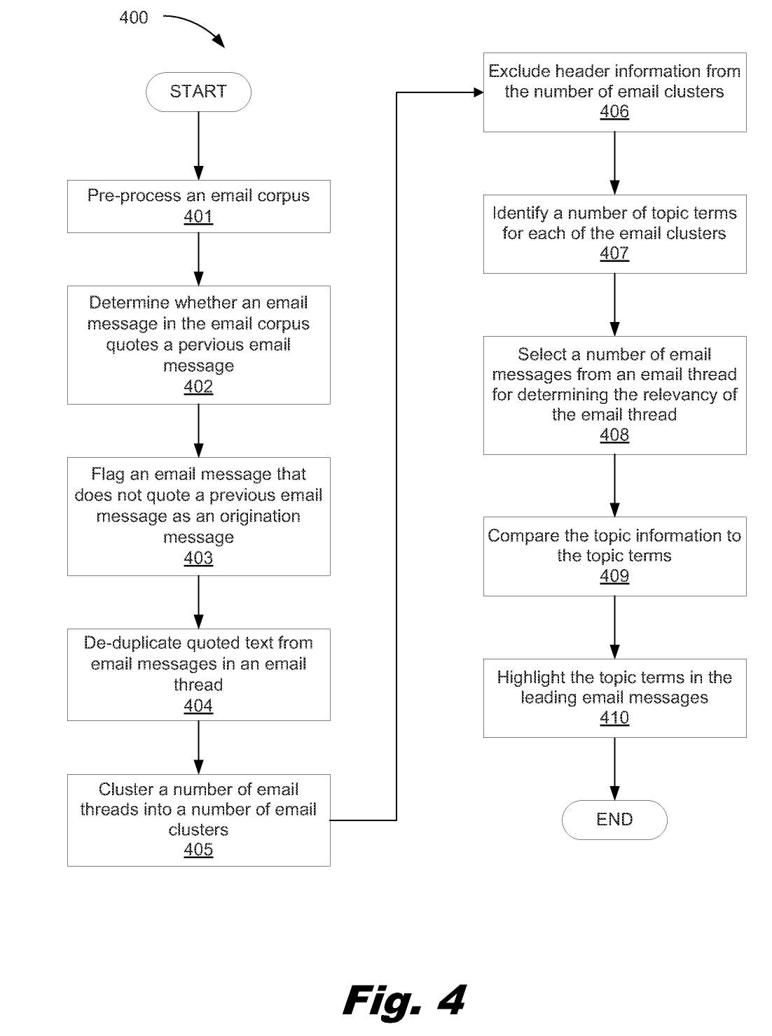

FIG. 4 is a flowchart of a method (400) for determining topic relevance of an email thread (FIG. 2, 205), according to one example of the principles described herein. The method (400) may be performed by the management device (FIG. 1, 103). The management device (FIG. 1, 103) may pre-process (block 401) the email corpus. Pre-processing (block 401) may condition the email corpus to be further analyzed by the management device (FIG. 1, 103). As described above, email messages (FIG. 2, 206) may be unique from other electronic communications in their formatting and use of certain types of text, including, boilerplate language and signature lines. Accordingly, the management device (FIG. 1, 103) may pre-process (block 401) the email corpus by removing these elements from the email messages (FIG. 2, 206).

The management device (FIG. 1, 103) may identify a number of email messages (FIG. 2, 206) in the email corpus as origination messages. As described above, origination messages are email messages (FIG. 2, 206) that may be initial messages in email threads (FIG. 2, 205). For example, the email corpus may include a number of email messages (FIG. 2, 206). A subset of those email messages (FIG. 2, 206) may be email messages (FIG. 2, 206) that are the starting points for email threads (FIG. 2, 205). For example, a first email message (FIG. 2, 206) may be the origination message in a first email thread (FIG. 2, 205). Similarly, a second email message (FIG. 2, 206) may be an origination message (FIG. 2, 206) in a second, and different, email thread (FIG. 2, 205).

Identifying a number of email messages as origination messages may include determining (block 402) whether an email message (FIG. 2, 206) quotes a previous email message (FIG. 2, 206). As described above, the nature of email messages (FIG. 2, 206) renders them problematic for conventional text mining procedures. One example is the practice of quoting earlier email messages (FIG. 2, 206). Thus, an email message (FIG. 2, 206) that does not quote a previous email message (FIG. 2, 206) may be an initial email message (FIG. 2, 206) in an email thread (FIG. 2, 205). Accordingly, the management device (FIG. 1, 103) may flag (block 403) an email message (FIG. 2, 206) that does not quote a previous email message (FIG. 2, 206) as an origination message.

The management device (FIG. 1, 103) may de-duplicate (block 404) quoted text from email threads (FIG. 2, 205). As described above, a number of email messages (FIG. 2, 206) in an email thread (FIG. 2, 205) may quote previous email messages (FIG. 2, 206) in the email thread (FIG. 2, 205) Accordingly, the management device (FIG. 1, 103) may de-duplicate (block 404) the quoted text in subsequent email messages (FIG. 2, 206). De-duplicating (block 404) quoted text as described herein may be beneficial in that subsequent email messages (FIG. 2, 206) may not be identified as relevant merely because they quote earlier topic information (FIG. 2, 207).

The management device (FIG. 1, 103) may cluster (block 405) a number of email threads (FIG. 2, 205) into a number of email clusters. As described above, email clusters may refer to groups of email messages (FIG. 2, 206) that are more similar to each other in some way than email messages (FIG. 2, 206) in other email clusters. Accordingly, the management device (FIG. 1, 103) may identify email threads (FIG. 2, 205) that are similar to one another in some way, and may group those email threads (FIG. 2, 205), together into an email cluster. Clustering the email threads (FIG. 2, 205) in this fashion may be beneficial in that it simplifies the identification of topic terms, generates narrower topic terms, and produces more relevant topic mining results. In some examples, the management device (FIG. 1, 103) may cluster (block 405) the email threads (FIG. 2, 205) into email clusters of approximately the same size. In other words, each email cluster may include approximately the same amount of email messages (FIG. 2, 206).

The management device (FIG. 1, 103) may exclude (block 406) header information from the number of email clusters. In some examples, the management device (FIG. 1, 103) may determine topic terms based on just the bodies of the email messages (FIG. 2, 206) in the email threads (FIG. 2, 205). Accordingly, the management device (FIG. 1, 103) may exclude (block 406) header information that is not part of the body of the email messages (FIG. 2, 206). More specifically, the management device (FIG. 1, 103) may exclude, a “to” field, a “from” field, a “cc” field, a “bcc” field, among other header information. In some examples, the subject line of an email message (FIG. 2, 206) may be included in the body of an email message (FIG. 2, 206), and accordingly, may be retained in the email clusters.

The management device (FIG. 1, 103) may identify (block 407) a number of topic terms for each of the email clusters. In some examples, this may include identifying (block 303) high information gain terms and from those high information gain terms, identifying (block 304) topic terms as described in connection with FIG. 3.

The management device (FIG. 1, 103) may select (block 408) a number of email messages (FIG. 2, 206) from an email thread (FIG. 2, 205) for use in determining the relevance of the email thread (FIG. 2, 205). As described above, in some examples, the management device (FIG. 1, 103) may determine the relevancy of an email thread (FIG. 2, 205) based on a few email messages (FIG. 2, 206) that are contain a large amount of topic information (FIG. 2, 207), i.e., the leading, or first few email messages (FIG. 2, 206) in an email thread (FIG. 2, 205). Accordingly, the management device (FIG. 1, 103) may select these leading email messages (FIG. 2, 206) for use in determining the relevancy of the email thread (FIG. 2, 205).

The management device (FIG. 1, 103) may then compare (block 409) the topic information (FIG. 2, 207) found in the email messages (FIG. 2, 206) of an email thread (FIG. 2, 205) with the topic terms for the email cluster to determine whether the email thread (FIG. 2, 205) is relevant. In some examples, comparing block (409) the topic information (FIG. 2, 207) with the topic terms may include determining the topic information (FIG. 2, 207) of the leading email messages (FIG. 2, 206). In some examples, the topic information (FIG. 2, 207) may be determined from the bodies of the email messages (FIG. 2, 206). Lastly, in some examples, the management device (FIG. 1, 103) may highlight (block 410) the topic terms in the leading email messages (FIG. 2, 206).

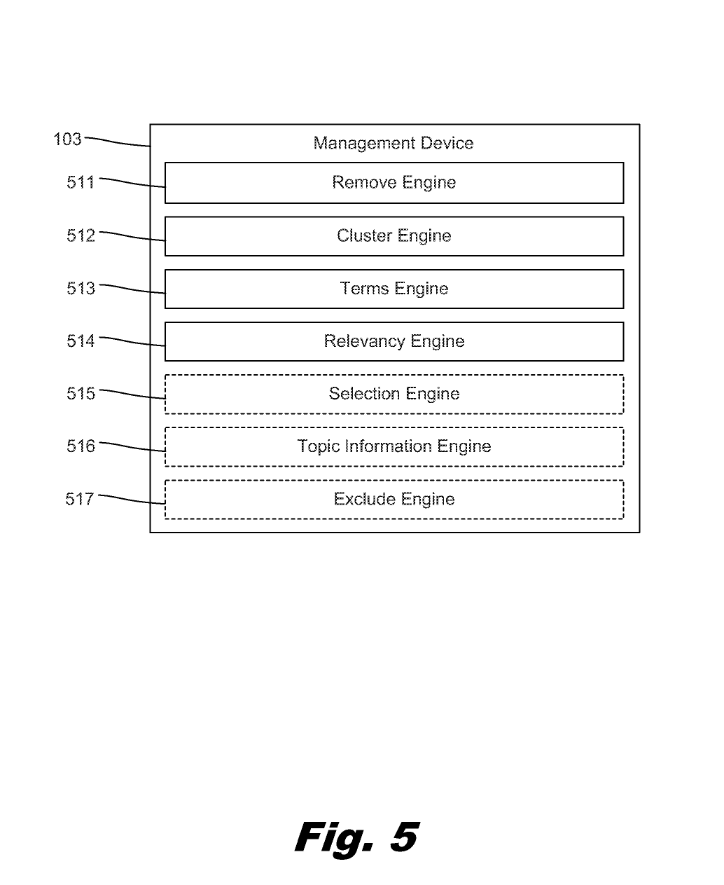

FIG. 5 is a diagram of a management device (103), according to one example of the principles described herein. The management device (103) may include a remove engine (511), a cluster engine (512), a terms engine (513), and a relevancy engine (514). In this example, the management device (103) may also include a selection engine (515), a topic information engine (516), and an exclude engine (517). The engines (511, 512, 513, 514, 515, 516, 517) refer to a combination of hardware and program instructions to perform a designated function. Each of the engines (511, 512, 513, 514, 515, 516, 517) may include a processor to execute the designated function of the engine.

The remove engine (511) may remove redundancies from an email thread (FIG. 2, 205), for example, by de-duplicating quoted text from email messages (FIG. 2, 206) of the email thread (FIG. 2, 205).

The duster engine (512) may duster a number of email threads (FIG. 2, 205) into a number of email dusters. The email dusters may include approximately the same amount of email messages (FIG. 2, 206). The terms engine (513) may identify a number of topic terms for each email cluster. For example, the terms engine (513) may identify high information gain terms for each email cluster and from those high information gain terms may identify topic terms that relate to the topic of the email duster.

The relevancy engine (514) may determine the relevance of each email thread (FIG. 2, 205) in an email cluster. The relevancy engine (514) may use a threshold number of email messages (FIG. 2, 206) in the email thread (FIG. 2, 205), the first few email messages (FIG. 2, 206) for example, to determine whether the topic information (FIG. 2, 207) in that email thread (FIG. 2, 205) is relevant to the topic of the email cluster. Accordingly, the selection engine (515) may select which email messages (FIG. 2, 206) to use in determining relevancy of the email thread (FIG. 2, 205). The topic information engine (516) may determine the topic information (FIG. 2, 207) of the threshold number of email messages (FIG. 2, 206), or leading email messages (FIG. 2, 206). The exclude engine (517) may exclude a header portion from the email threads (FIG. 2, 205) in the email clusters. In this example, the terms engine (513) may identify the topic terms based on the text contained in the bodies of the email messages (FIG. 2, 206) in the email clusters.

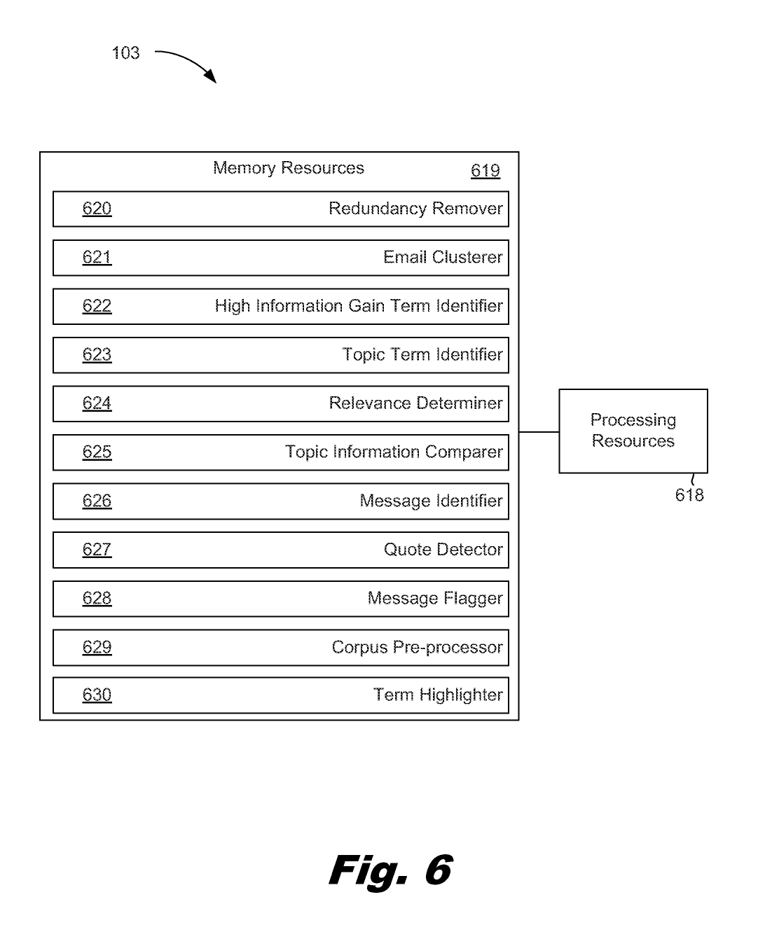

FIG. 6 is another diagram of a management device (103), according to one example of the principles described herein. In this example, the management device (103) may include processing resources (618) that are in communication with memory resources (619). Processing resources (618) may include at least one processor and other resources used to process programmed instructions. The memory resources (619) represent generally any memory capable of storing data such as programmed instructions or data structures used by the activity stream manager (103). The programmed instructions shown stored in the memory resources (619) may include a redundancy remover (620), an email clusterer (621), a high information gain term identifier (622), a topic term identifier (623), a relevance determiner (624), a topic information comparer (625), a message identifier (626), a quote detector (627), a message flagger (628), a corpus pre-processor (629), and a term highlighter (630).

The memory resources (619) include a computer readable storage medium that contains computer readable program code to cause tasks to be executed by the processing resources (618). The computer readable storage medium may be tangible and/or physical storage medium. The computer readable storage medium may be any appropriate storage medium that is not a transmission storage medium. A non-exhaustive list of computer readable storage medium types includes non-volatile memory, volatile memory, random access memory, write only memory, flash memory, electrically erasable program read only memory, or types of memory, or combinations thereof.

The redundancy remover (620) represents programmed instructions that, when executed, cause the processing resources (618) to remove redundancy from email messages (FIG. 2, 206) in an email thread (FIG. 2, 205). The email clusterer (621) represents programmed instructions that, when executed, cause the processing resources (618) to group a number of email threads (FIG. 2, 205) into a number of email clusters. The high information gain term identifier (622) represents programmed instructions that, when executed, cause the processing resources (618) to identify high information gain terms for each email cluster. The topic term identifier (623) represents programmed instructions that, when executed, cause the processing resources (618) to determine a number of topic terms from the high information gain terms. The relevance determiner (624) represents programmed instructions that, when executed, cause the processing resources (618) to determine a relevance of the number of email threads (FIG. 2, 205) in an email cluster based on the topic terms and a threshold number of email messages (FIG. 2, 206) in an email thread (FIG. 2, 205). Accordingly, a topic information comparer (625) represents programmed instructions that, when executed, cause the processing resources (618) to compare topic information in the email messages (FIG. 2, 206) to the topic terms.

The message identifier (626) represents programmed instructions that, when executed, cause the processing resources (618) to identify a number of email messages (FIG. 2, 206) in the email corpus that are origination messages. The quote detector (627) represents programmed instructions that, when executed, cause the processing resources (618) to determine whether an email message (FIG. 2, 206) in the email corpus quotes a previous email message (FIG. 2, 206). The message flagger (628) represents programmed instructions that, when executed, cause the processing resources (618) to flag an email message (FIG. 2, 206) that does not quote a previous email message (FIG. 2, 206) as an origination message. The corpus pre-processor (629) represents programmed instructions that, when executed, cause the processing resources (618) to pre-process the email corpus. Lastly, the term highlighter (630) represents programmed instructions that, when executed, cause the processing resources (618) to highlight the topic terms in the leading email messages (FIG. 2, 206).

Further, the memory resources (619) may be part of an installation package. In response to installing the installation package, the programmed instructions of the memory resources (619) may be downloaded from the installation package's source, such as a portable medium, a server, a remote network location, another location, or combinations thereof. Portable memory media that are compatible with the principles described herein include DVDs, CDs, flash memory, portable disks, magnetic disks, optical disks, other forms of portable memory, or combinations thereof. In other examples, the program instructions are already installed. Here, the memory resources can include integrated memory such as a hard drive, a solid state hard drive, or the like.

In some examples, the processing resources (618) and the memory resources (619) are located within the same physical component, such as a server, or a network component. The memory resources (619) may be part of the physical component's main memory, caches, registers, non-volatile memory, or elsewhere in the physical component's memory hierarchy. Alternatively, the memory resources (619) may be in communication with the processing resources (618) over a network. Further, the data structures, such as the libraries, may be accessed from a remote location over a network connection while the programmed instructions are located locally. Thus, the management device (FIG. 1, 103) may be implemented on a user device, on a server, on a collection of servers, or combinations thereof.

The management device (103) of FIG. 6 may be part of a general purpose computer. However, in alternative examples, the management device (103) is part of an application specific integrated circuit.

Methods and systems for determining topic relevance of an email thread based on a subset of email messages (i.e., origination messages) in an email corpus may have a number of advantages, including: (1) removing extraneous knowledge gathering; (2) reducing topic mining processing time; (3) maintaining the value of the topic mining process; and (4) improving the utility of the topic mining process.

The preceding description has been presented to illustrate and describe examples of the principles described. This description is not intended to be exhaustive or to limit these principles to any precise form disclosed. Many modifications and variations are possible in light of the above teaching.

What is claimed is:

1. A method for determining topic relevance of an email thread with an electronic device, comprising:
removing redundancy from email messages in an email thread;
grouping a number of email threads into a number of email clusters;
identifying high information gain terms for each email cluster;
identifying topic terms for each email duster from the high information gain terms; and
determining a relevance of the number of email threads in an email cluster based on the topic terms for the email cluster and a threshold number of email messages in an email thread.

2. The method of claim 1, in which the number of email messages in an email thread are leading email messages in an email thread.

3. The method of claim 1, in which determining the relevance of the number of email threads in an email cluster comprises comparing topic information in the threshold number of email messages with the topic terms for the email cluster.

4. The method of claim 3, in which the topic information is found in the bodies of the email messages in the email thread.

5. The method of claim 1, further comprising identifying a number of email messages in the email corpus as origination messages.

6. The method of claim 5, in which identifying a number of email messages as origination messages comprises:
determining whether an email message in the email corpus quotes a previous email message; and
flagging an email message that does not quote a previous email message as an origination message.

7. The method of claim 1, in which the topic terms are high information gain terms that relate to a topic of an email cluster.

8. A system for determining topic relevance of an email thread, comprising:
a de-duplicate engine to de-duplicate quoted text from email messages in an email thread;
a cluster engine to cluster a number of email threads into email clusters;
a terms engine to identify a number of topic terms for each of the email clusters; and
a relevancy engine to determine a relevance of the number of email threads in the email clusters based on the number of topic terms and a threshold number of email messages in each email thread.

9. The system of claim 8, further comprising a selection engine to select the threshold number of email messages from each email thread.

10. The system of claim 8, further comprising a topic information engine to determine the topic information of the threshold number of email messages in each email thread.

11. The system of claim 8, further comprising an exclude engine that excludes header information from the email threads in the email clusters.

12. The system of claim 8, in which the number of email clusters include approximately the same amount of email messages.

13. A computer program product for determining topic relevance of an email thread, the computer program product comprising:
a computer readable storage medium comprising computer usable program code embodied therewith, the computer usable program code comprising computer usable program code to, when executed by a processor, to:
remove quotations of a first number of email messages from a second number of email messages in an email thread;
cluster a number of email threads into a number of email clusters;
determine a number of high information gain terms in an email cluster;
determine a number of topic terms from the high information gain terms; and
determine the relevancy of a number of email threads within each email cluster based on the topic terms.

14. The computer program product of claim 13, further comprising computer usable program code to, when executed by a processor, pre-process an email corpus containing a number of email threads.

15. The computer program product of claim 13, further comprising computer usable program code to, when executed by a processor, highlight the topic terms in a threshold number of email messages in the number of email threads.
